(19) United States
(12) Patent Application Publication
(10) Pub. No.: US 2009/0013067 A1
(43) Pub. Date: Jan. 8, 2009

(54) Data transfer system, data transfer method and data transfer apparatus

(75) Inventors: Shunsuke Kikuchi, Kawasaki (JP); Yuji Nomura, Kawasaki (JP); Takao Kato, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/230,994

(22) Filed: Sep. 9, 2008

Related U.S. Application Data
(63) Continuation of application No. PCT/JP2006/305574, filed on Mar. 20, 2006.

(51) Int. Cl. G06F 15/173

(52) U.S. Cl. 709/223

(57) ABSTRACT

A transmitter-side access point measures a transmission delay between the transmitter-side access point and a receiver-side access point, and calculates a threshold based on the transmission delay. Unless the amount of data from a source user terminal exceeds the threshold, the transmitter-side access point transmits data over a network in response to a request from the receiver-side access point. When the amount of data from the source user terminal exceeds the threshold, the data is transported as being stored in a physical medium to the receiver-side access point through transportation service. The receiver-side access point obtains the data from the transported physical medium, and transfers the data to a destination user terminal.

### BACKGROUND OF THE INVENTION

1. Field of the Invention

The present invention relates to a data transfer system, a data transfer method, and a data transfer apparatus for transferring data from a source terminal to a destination terminal.

2. Description of the Related Art

Upon exchanging data between two terminals that are distant from each other, a file server on a network is generally used to temporarily store and transfer the data, instead of these terminals directly exchanging the data. Such a file server is hereinafter referred to as a “network file sharing apparatus”, and a service provided by such an apparatus is referred to as a “network file sharing service”.

FIG. 7 is a schematic diagram for explaining a conventional network file sharing service. As shown in FIG. 7, a network file sharing apparatus 30 is physically located in a predetermined location (via a network connection). User terminals 10 and 20, using the service provided by the network file sharing apparatus 30, access the network file sharing apparatus 30 over the network. The user terminal 10 transmitting data uploads the data to the network file sharing apparatus 30, and the user terminal 20 receiving the data downloads the uploaded data.

By utilizing this network file sharing service, users no longer need to purchase apparatuses for transmitting and receiving data (e.g., a server) on their own. Moreover, the data can be transmitted and received without installing a special apparatus or software to an existing environment.

There is another method for exchanging data between two terminals that are distant from each other, in addition to the one that uses the network file sharing service as described above. In this method, a user stores the data in a storage medium (e.g., a magnetic storage device such as a hard disk, a magneto-optical medium, or a non-volatile memory) and uses a general transportation service to physically transport the data to the receiving user. This method is hereinafter referred to as “storage-medium-based transportation”.

Because of increasing storage capacity of storage media (especially of a hard disk) and development of logistics, the storage-medium-based transportation enables a large amount of data to be sent and received at one time in a relatively low cost, advantageously.

Japanese Patent Application Laid-open No. H10-150460 discloses a technology where a plurality of pieces of video data are provided as a plurality of shared files over a network, and a radio station, upon receiving a request for the video data from a user terminal, reads the video data from the shared files, and transmits the video data to the user terminal. In this manner, high quality video data can be transmitted and received to the user terminals without sacrificing the throughput.

However, according to the conventional technologies described above, the throughput cannot be increased with less cost for the network file sharing service.

Transmission Control Protocol/Internet Protocol (TCP/IP), which is currently being used as a set of standard protocols for a packet network, has a characteristic that the throughput is inversely proportional to a packet transmission delay (round trip time: RTT).

In other words, according to the data transfer using TCP/IP, when the packet transmission delay increases to a certain level, the throughput cannot be increased any further regardless of an actual network bandwidth available. Considering the network file sharing service shown in FIG. 7, this problem becomes prominent when the user terminals 10 and 20, which are exchanging the data, are geographically separated by a predetermined distance, and the packet transmission delay is large between the user terminals 10, 20 and the network file sharing apparatus 30. For example, the packet transmission delay between Japan and the United States is approximately 100 [msec]. Therefore, if a system with a window size of 64 kilobytes is used, the throughput is 5.1 [Mbps]. Even if the network has a bandwidth of 100 [Mbps], the throughput stays at 5.1 [Mbps].

One approach to the problem is to modify the protocols used for the network transmission. However, to modify the protocol, it is necessary to install a special device or software to the network file sharing apparatus 30 and the user terminals 10 and 20. This leads to an increase of system costs (the advantage of the network file sharing service, eliminating the need for installing a special device or software, is lost). Moreover, it is very difficult to install the special device or software to each of the apparatuses using the network file sharing service, when communications are established with a number of the specified apparatuses.

On the contrary, in the storage-medium-based transportation, a large volume of data can be sent at one time. However, some human interventions are required in tasks such as storing the data in a medium, taking it out at the receiving side, passing the medium to a service person, and receiving the medium. In the current environment where the data themselves are processed in the terminals connected to the network, the costs for such tasks are very expensive, and a burden to the users also increases.

In addition, the receiver cannot access data stored in a medium at all until the medium itself delivered to the destination. For example, the sender cannot even communicate index information, describing what kind of information was sent, to the receiver. Furthermore, in some situations, if part of data is transmitted at first, the data can be utilized in some way; however, such operation is not available.

### SUMMARY

It is an object of the present invention to at least partially solve the problems in the conventional technology.

According to an aspect of the present invention, there is provided a data transfer system that transfers data from a source terminal to a destination terminal, including: a measuring unit that measures transfer time taken to transfer data from the source terminal to the destination terminal; a determining unit that determines, based on the transfer time measured by the measuring unit, whether to transfer the data over a network from the source terminal to the destination terminal or to transport the data as being stored in a physical medium from the source terminal to the destination terminal; and an obtaining unit that obtains the data from any one of the network connected to the source terminal and the physical medium. When an amount of data transferred over the network to the destination terminal exceeds a predetermined threshold, the data is transported as being stored in the physical medium.

According to another aspect of the present invention, there is provided a data transfer method for transferring data from a source terminal to a destination terminal, including: measuring transfer time taken to transfer data from the source terminal to the destination terminal; determining whether to transfer the data over a network from the source terminal to the destination terminal or to transport the data as being stored in a physical medium from the source terminal to the destination terminal based on the transfer time and whether an amount of data transferred over the network to the destination terminal exceeds a predetermined threshold; and obtaining the data from any one of the network connected to the source terminal and the physical medium.

According to still another aspect of the present invention, there is provided a data transfer apparatus that transfers data to a destination terminal, including: a measuring unit that measures transfer time taken to transfer data to the destination terminal; and a determining unit that determines, based on the transfer time measured by the measuring unit, whether to transfer the data over a network to the destination terminal or to transport the data as being stored in a physical medium to the destination terminal.

The above and other objects, features, advantages and technical and industrial significance of this invention will be better understood by reading the following detailed description of presently preferred embodiments of the invention, when considered in connection with the accompanying drawings

### BRIEF DESCRIPTION OF THE DRAWINGS

FIG. 1 is a schematic diagram for explaining the overview of an embodiment of the present invention;

FIG. 2 is a functional block diagram of a transmitter-side access point shown in FIG. 1;

FIG. 3 is a functional block diagram of a receiver-side access point shown in FIG. 1;

FIGS. 4 to 6 are flowcharts of a data transfer process according to the embodiment; and

FIG. 7 is a schematic diagram for explaining a conventional network file sharing service.

### DETAILED DESCRIPTION OF THE PREFERRED EMBODIMENTS

Exemplary embodiments of the present invention are explained in detail below with reference to the accompanying drawings.

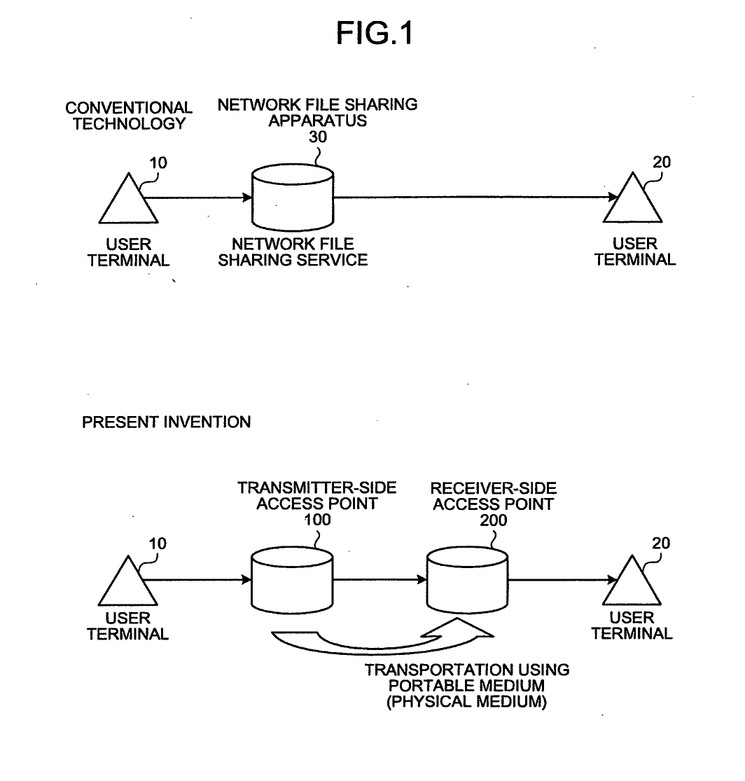

Described below is the general overview of an embodiment of the present invention. FIG. 1 is a schematic diagram for explaining the overview of an embodiment of the present invention. As shown in FIG. 1, according to the embodiment, “access points (a transmitter-side access point 100 and a receiver-side access point 200)”, corresponding to the network file sharing apparatus 30 in the conventional network file sharing service, are located in a geographically distributed manner. A system including the user terminals 10 and 20, the transmitter-side access point 100, and the receiver-side access point 200 is hereinafter referred to as a “network file sharing system”.

The transmitter-side access point 100 measures the transfer time (transmission delay) from the transmitter-side access point 100 to the receiver-side access point 200, and determines whether to send the data over the network or to transport it as being stored in a physical medium to the receiver-side access point 200 based on the transmission delay. The receiver-side access point 200 obtains the data over the network or from the physical medium, and transfers the data to the user terminal 20.

In this manner, according to the embodiment, data is passed from the transmitter-side access point 100 to the receiver-side access point 200 using both (or one) of data transfer over network and data transportation using a physical medium. Therefore, it is possible to improve the throughput of data transfer with low cost, without changing the existing interface.

Various types of transportations are available, such as an airplane, a train, an automobile, or a ship, for transporting the physical medium from the transmitter-side access point 100 to the receiver-side access point 200, and any type of these transportations can be used. For example, if the transmitter-side access point 100 and the receiver-side access point 200 are installed in an airport, an airplane may be used as the transportation.

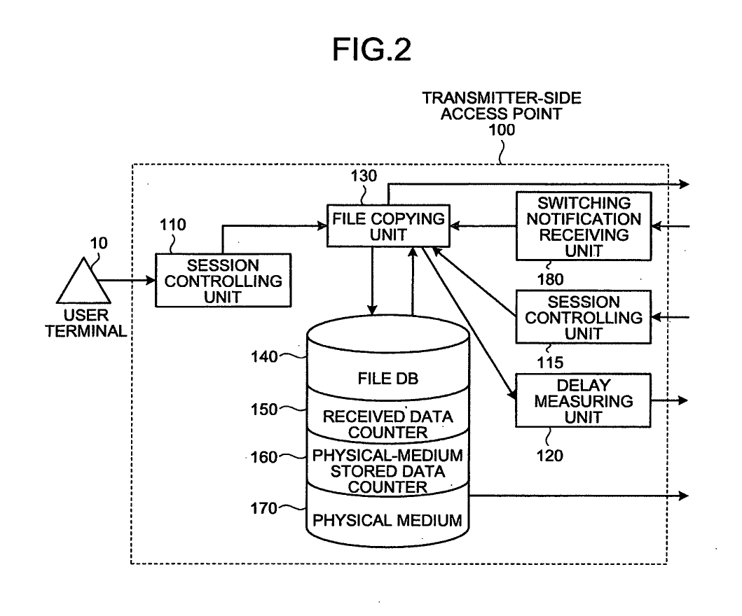

A structure of the transmitter-side access point 100 is described below. FIG. 2 is a functional block diagram of the transmitter-side access point 100. As shown in FIG. 2, this transmitter-side access point 100 includes session controlling units 110 and 115, a delay measuring unit 120, a file copying unit 130, a file database (DB) 140, a received data counter 150, a physical-medium stored data counter 160, a physical medium 170, and a switching notification receiving unit 180.

The session controlling unit 110 transmits and receives data to and from the user terminal 10 and the transmitter-side access point 100. The session controlling unit 115 transmits and receives data to and from the transmitter-side access point 100 and the receiver-side access point 200.

The delay measuring unit 120 measures a transmission delay between the transmitter-side access point 100 and the receiver-side access point 200. Specifically, the delay measuring unit 120 transmits a probe packet to the receiver-side access point 200, and measures a response delay for the transmitted probe packet as the transmission delay.

The file copying unit 130 stores data received from the user terminal 10 simultaneously in the file DB 140 and the physical medium 170. In response to a request received from the receiver-side access point 200, the file copying unit 130 transfers the data received from the user terminal 10 (the data stored in the file DB 140) to the receiver-side access point 200 over the network. Upon receiving information about a switching notification from the receiver-side access point 200, the file copying unit 130 stops or restarts data transfer depending on the content of the switching notification.

The file copying unit 130 records the amount of data received from the user terminal 10 on the received data counter 150, and records the amount of the data (received from the user terminal 10 and) stored in the physical medium 170 on the physical-medium stored data counter 160.

The file copying unit 130 also obtains data about the transmission delay from the delay measuring unit 120, calculates a disconnecting threshold, and manages disconnecting of the physical medium 170.

The file DB 140 stores therein the data received from the user terminal 10.

The received data counter 150 records the amount of the data that have been received from the user terminal 10. The physical-medium stored data counter 160 records the amount of the data that have been stored in the physical medium 170.

The physical medium 170 stores therein the data, and this physical medium 170 can be transported alone. The physical medium 170 has an interfacing function (of any interface format) that connects the file copying unit 130 in the transmitter-side access point 100 and a source determining unit 230 (described later) in the receiver-side access point 200. This physical medium 170 has a form that can be transported physically (e.g., a hard disk).

The switching notification receiving unit 180 receives a switching notification indicating which path is to be used for receiving the data (either over the network, or from the physical medium) from the receiver-side access point 200. The switching notification receiving unit 180 passes this information about the received switching notification to the file copying unit 130.

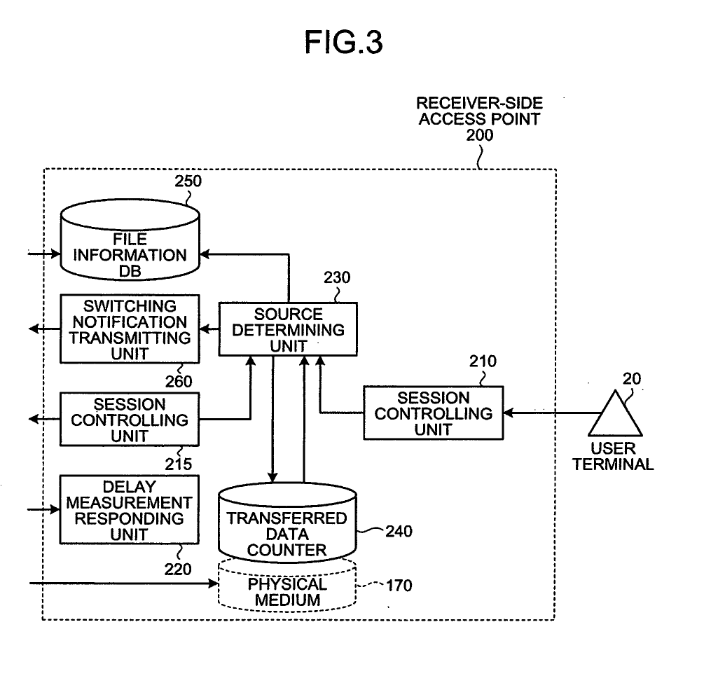

A structure of the receiver-side access point 200 is described below. FIG. 3 is a functional block diagram of the receiver-side access point 200. As shown in FIG. 3, this receiver-side access point 200 includes session controlling units 210 and 215, a delay measurement responding unit 220, the source determining unit 230, a transferred data counter 240, a file information DB 250, and a switching notification transmitting unit 260.

The session controlling unit 210 transmits and receives data to and from the user terminal 20 and the receiver-side access point 200. The session controlling unit 215 transmits and receives data to and from the transmitter-side access point 100 and the receiver-side access point 200.

The delay measurement responding unit 220 responds, upon receiving a probe packet from the transmitter-side access point 100, to the received probe packet.

The source determining unit 230 determines, upon receiving the data request from the user terminal 20, whether to receive the requested data over the network or from the physical medium 170. Specifically, upon receiving the data request from the user terminal 20, the source determining unit 230 refers to the file information DB 250, and determines if the requested data is in the network file sharing system. The file information DB 250 stores therein information about the data currently maintained in the network file sharing system. The file information DB 250 is shared between the transmitter-side access point 100 and the receiver-side access point 200 (the file information DB 250 may be located in any physical location).

If the source determining unit 230 determines that the requested data is not in the network file sharing system, notifying information is sent to the user terminal 20 to notify that the requested data is not in the network file sharing system.

If the requested data is in the network file sharing system, the source determining unit 230 further determines whether the physical medium 170 is located at the receiver-side access point 200. If the physical medium 170 is not present, the source determining unit 230 obtains the data from the transmitter-side access point 100 over the network, records the amount of the received data on the transferred data counter 240, and transfers the data to the user terminal 20. If the physical medium 170 is present at the receiver-side access point 200, the source determining unit 230 obtains the data from the physical medium 170, records the amount of the obtained data on the transferred data counter 240, and transfers the data to the user terminal 20.

The source determining unit 230 also switches the sources for obtaining data depending on conditions. For example, if the physical medium 170 is mounted at the receiver-side access point 200 while receiving the data from the transmitter-side access point 100 over the network, the source determining unit 230 stops receiving the data over the network, and obtains the remaining data from the physical medium 170. The source determining unit 230 can obtain the remaining data from the physical medium 170 by referring to the transferred data counter 240.

If the data is not complete upon completing obtaining the data recorded on the physical medium 170 (i.e., there is remaining data that has not been stored in the physical medium 170), the source determining unit 230 obtains the remaining data from the transmitter-side access point 100 over the network.

Upon switching the source for obtaining data (from the network to the physical medium 170, or from the physical medium 170 to the network), the source determining unit 230 transmits information to the transmitter-side access point 100, notifying that the source for obtaining data is being switched. The source determining unit 230 also has a function to check the end of the data.

The transferred data counter 240 records therein the amount of data that has been transmitted to the user terminal 20.

The switching notification transmitting unit 260 receives a switching notification, indicating which path is to be used for receiving the data (either over the network, or from the physical medium), from the source determining unit 230. The switching notification transmitting unit 260 passes the information about the received switching notification to the transmitter-side access point 100.

Described below is a data transfer process according to the embodiment. In the following description, the data transfer request process is divided into phases of: preparing environment; starting receiving data; starting transmitting data; starting transportation with a physical medium; switching from the network to the physical medium; switching again from the physical medium to the network; and completing the data transfer.

To begin with, the phase “preparing environment” is explained. In this phase, the transmitter-side access point 100 and the receiver-side access point 200 are operating, and both of these access points are connected over the network. Moreover, the transmitter-side access point 100 and the receiver-side access point 200 can be connected to the user terminals 10 and 20, respectively, over the network. The physical medium 170 is mounted at the transmitter-side access point 100 in a writable manner. A transportation system (service) for transporting the physical medium 170 is arranged to be functioning. In this example, the transmitter-side access point 100 and the receiver-side access point 200 are respectively installed in different airports, and an airplane is used for transporting the physical medium.

The phase “starting receiving data” is then explained. In this phase, the user terminal 10 starts transmitting data to the transmitter-side access point 100 over the network. At this time, the session controlling unit 110 in the transmitter-side access point 100 manages the transmission and reception of the data. The data is generally transmitted using File Transfer Protocol (FTP) or Hypertext Transfer Protocol (HTTP); however, the transmission is not limited to a particular method. Moreover, additional functions or processes, such as authentication or accounting, can be performed.

The file copying unit 130 performs following four processes upon starting receiving the data from the user terminal 10. In the first process, the file copying unit 130 transmits file information (e.g., a file name) of the data received from the user terminal 10 to the receiver-side access point 200, and the receiver-side access point 200 stores the file information in the file information DB 250.

In the second process, the file copying unit 130 instructs the delay measuring unit 120 to measure the transmission delay between the transmitter-side access point 100 and the receiver-side access point 200. The file copying unit 130 then outputs the transmission delay to a display apparatus (not shown), for example, to have the delay displayed thereon.

In the third process, the file copying unit 130 stores the data received from the user terminal 10 in the file DB 140, and at the same time records the amount of data on the received data counter 150.

In the fourth process, the file copying unit 130 stores the data received from the user terminal 10 in the physical medium 170, and at the same time records the amount of data on the physical-medium stored data counter 160.

The delay measuring unit 120 in the transmitter-side access point 100 receives the instruction from the file copying unit 130, transmits the probe packet to the delay measurement responding unit 220 in the receiver-side access point 200, and measures the time required for a response packet from the delay measurement responding unit 220 to be returned.

This is a function generally called Packet Internet Groper (Ping). For example, if the transmitter-side access point 100 and the receiver-side access point 200 are respectively located in Japan and the United States, the transmission delay is approximately 100 [msec].

The phase “starting transmitting a file” is explained below. In this phase, the user terminal 20 makes access to the receiver-side access point 200 over the network, and starts a data receiving process. At this time, the session controlling unit 210 in the receiver-side access point 200 manages the transmission and reception of the data. The data is generally transmitted over FTP or HTTP; however, the transmission is not limited to a particular method. Moreover, additional functions or processes, such as authentication or accounting, may be performed.

Upon receiving a data receiving request, the source determining unit 230 in the receiver-side access point 200 refers to the file information DB 250, and determines if the requested data is in the network file sharing system. If the requested data is not in the network file sharing system, the source determining unit 230 notifies the user terminal 20 that the data is not in the network file sharing system, and ends the process.

The source determining unit 230 determines if the physical medium 170 is mounted at the receiver-side access point 200. Because the physical medium 170 is not mounted when the receiver-side access point 200 receives the data request from the user terminal 20, the source determining unit 230 requests the transmitter-side access point 100 to transmit the data via the session controlling unit 215.

Upon receiving a data transfer request from the receiver-side access point 200, the transmitter-side access point 100 starts transmitting data over the network. In the transmitter-side access point 100, the file copying unit 130 reads the data from the file DB 140, and transmits the data via the session controlling unit 115. At this time, the session controlling units 115 and 210 in each of the access points manage the transmission and reception of the data. The data is generally transmitted and received over FTP or HTTP; however, the transmission and the reception are not limited to a particular method. Upon receiving the data, the receiver-side access point 200 transfers the received data to the user terminal 20. At this time, the receiver-side access point 200 records the amount of the transferred data on the transferred data counter 240.

The phase “starting transportation with the physical medium” is explained below. When the transmission delay is obtained from the delay measuring unit 120, the file copying unit 130 calculates a switching threshold. The switching threshold is calculated in a manner described below. At first, the throughput of the network is calculated. The throughput Th can be obtained by:

Th[bps]=Rwin[bit]/RTT[sec]

For example, assuming that Rwin is 64 [kByte], which is the value commonly used in a current system, and RTT, which is the transmission delay measured by the delay measuring unit 120, is 100 [msec] (assuming the access points are located in Japan and the United States), then the throughput Th is 5.1 [Mbps].

After obtaining the throughput, the file copying unit 130 multiplies the throughput Th with time S [sec] required for transporting the physical medium 170 to obtain X [Byte], which is the transmission capacity in a unit time (i.e., the switching threshold). For example, the transportation time is approximately 18 hours between Japan and the United States. Therefore, the switching threshold is 41.31 [GByte]. The file copying unit 130 may store therein information about the transportation time, or may obtain the information from an input apparatus (not shown).

The switching threshold may be manually calculated by a service provider (operator). In this scenario, the operator inputs from the input apparatus the data about the calculated switching threshold to the file copying unit 130.

The file copying unit 130 compares the amount of the data recorded on the received data counter 150 with the switching threshold, and waits until the amount of the data recorded on the received data counter 150 reaches the switching threshold. When the amount of the data recorded on the received data counter 150 exceeds the switching threshold, the file copying unit 130 outputs this information to the display apparatus (not shown), and disconnects the physical medium 170 from the transmitter-side access point 100. Upon disconnecting the physical medium 170, the file copying unit 130 stops updating the physical-medium stored data counter 160.

After being disconnected from the transmitter-side access point 100, the physical medium 170 is transported to the receiver-side access point 200 via an airplane. After the physical medium 170 arrives at the receiver-side access point 200, an operator mounts the physical medium 170 to the receiver-side access point 200.

In other words, the file copying unit 130 keeps comparing the amount of the data recorded on the received data counter 150 with the switching threshold, and determines if the amount of the data recorded on the received data counter 150 exceeds the switching threshold. If the amount of the data recorded on the received data counter 150 is equal or below the switching threshold, the file copying unit 130 transmits the data over the network. If the amount of the data recorded on the received data counter 150 exceeds the switching threshold, the file copying unit 130 determines the disconnection of the physical medium 170 to transport the data to the receiver-side access point 200.

The phase “switching from the network to the physical medium” is explained below. In the receiver-side access point 200, the source determining unit 230 determines if the physical medium 170 is mounted while receiving the data over the network and transferring the data to the user terminal 20. When the physical medium 170 is mounted at the receiver-side access point 200, following three processes are performed.

In the first process, the source determining unit 230 instructs the switching notification transmitting unit 260 to send the switching notification to the transmitter-side access point 100 to notify that the data is to be read from the physical medium 170.

In the second process, the source determining unit 230 stops reading the data over the network. In the third process, the source determining unit 230 starts reading the data from the physical medium 170 and transferring the data to the user terminal 20. At this time, the source determining unit 230 refers to the transferred data counter 240, and starts reading the data that corresponds to the data next to the one recorded on the transferred data counter 240.

The switching notification transmitting unit 260 in the receiver-side access point 200 receives the instruction from the source determining unit 230, and transmits the switching notification (to switch from the network to the physical medium 170) to the switching notification receiving unit 180 in the transmitter-side access point 100.

When receiving the switching notification (to switch from the network to the physical medium 170), the switching notification receiving unit 180 passes the switching notification to the file copying unit 130. Upon receiving the notification, the file copying unit 130 stops transmitting the data over the network.

The phase “switching again from the physical medium to the network” is now explained below. If the source determining unit 230 in the receiver-side access point 200 finishes reading all the data in the physical medium 170 and transfers the data to the user terminal 20 but the data transfer has not completed, the switching takes place again. The data transfer is determined to be completed when a mark indicating the end of the data (End of File: EOF) is detected. In other words, even if the source determining unit 230 finished reading all of the data from the physical medium 170, the switching takes place again as long as the EOF is not included in the read data.

To perform the switching again, the source determining unit 230 instructs the switching notification transmitting unit 260 to notify the transmitter-side access point 100 that the data is to be read over the network. The source determining unit 230 then waits for the data to arrive from the transmitter-side access point 100 over the network. Once the data starts arriving, the source determining unit 230 starts transferring the data to the user terminal 20.

The switching notification transmitting unit 260 in the receiver-side access point 200 receives the instruction from the source determining unit 230, and transmits the switching notification (to switch from the physical medium 170 to the network) to the switching notification receiving unit 180 in the transmitter-side access point 100.

Upon receiving the switching notification (to switch from the physical medium 170 to the network), the switching notification receiving unit 180 in the transmitter-side access point 100 passes the received data to the file copying unit 130. Upon receiving the switching notification (to switch from the physical medium 170 to the network), the file copying unit 130 starts transmitting the data over the network (to the session controlling unit 115). The file-copying unit 130 refers to the physical-medium stored data counter 160, and transmits the data next to the one recorded thereon.

The phase “completing the data transfer” is explained below. There are three patterns of how the data transfer is completed. That is, the data transfer is completed before the physical medium 170 is disconnected from the transmitter-side access point 100; the data transfer is completed by the receiver-side access point 200 reading the data from the physical medium 170; or the data transfer is completed by the receiver-side access point 200 reading the data from the physical medium 170, and again over the network.

Described below is the scenario where “the data transfer is completed before the physical medium 170 is disconnected from the transmitter-side access point 100”. In this scenario, the amount of the data recorded on the received data counter 150 does not exceed the switching threshold. In this situation, the data is only transmitted over the network, and completed. The physical medium 170 is not transported at all. The transmitter-side access point 100 and the receiver-side access point 200 close a session controlling function upon completion of the data transfer, delete the data from the file DB 140, the physical medium 170, and the file information DB 250, and initialize the values of the received data counter 150, the physical-medium stored data counter 160, and the transferred data counter 240.

Described below is the scenario where “the data transfer is completed by the receiver-side access point 200 reading the data from the physical medium 170”. In this scenario, the data transfer from the user terminal 10 has been completed before the physical medium 170 is disconnected from the transmitter-side access point 100. In this situation, all of the data transmitted from the user terminal 10 is stored in the physical medium 170. When the data transfer from the physical medium 170 has been completed, the receiver-side access point 200 closes the session controlling function, deletes the data in the physical medium 170 and the file information DB 250, and initializes the value of the transferred data counter 240.

Described below is the scenario where “the data transfer is completed by the receiver-side access point 200 reading the data from the physical medium 170 again over the network”. In this scenario, the data transfer from the user terminal 10 has not been completed by the time the physical medium 170 is disconnected from the transmitter-side access point 100. Not all the data transmitted from the user terminal 10 are stored in the physical medium 170, and the remaining data are accumulated in the file DB 140 in the transmitter-side access point 100. The ending process is the same as that explained for the scenario, “the data transfer is completed before the physical medium 170 is disconnected from the transmitter-side access point 100”. Therefore, the explanation thereof is omitted herein (except that the data in the physical medium 170 is initialized at the receiver-side access point 200).

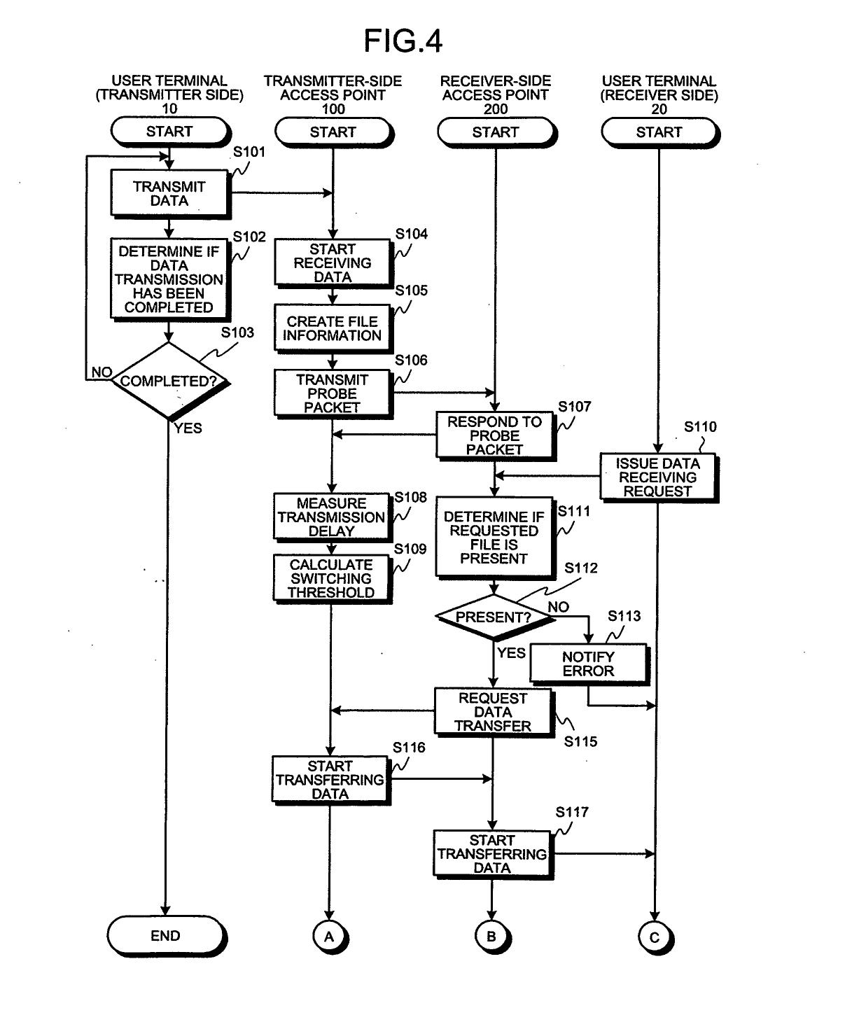

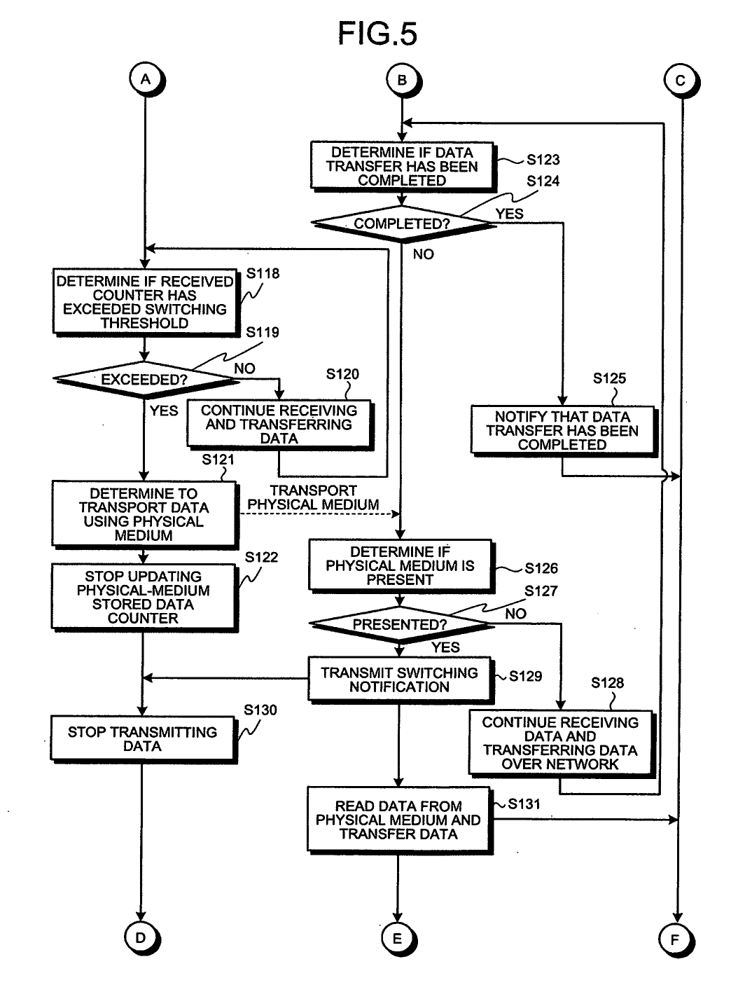

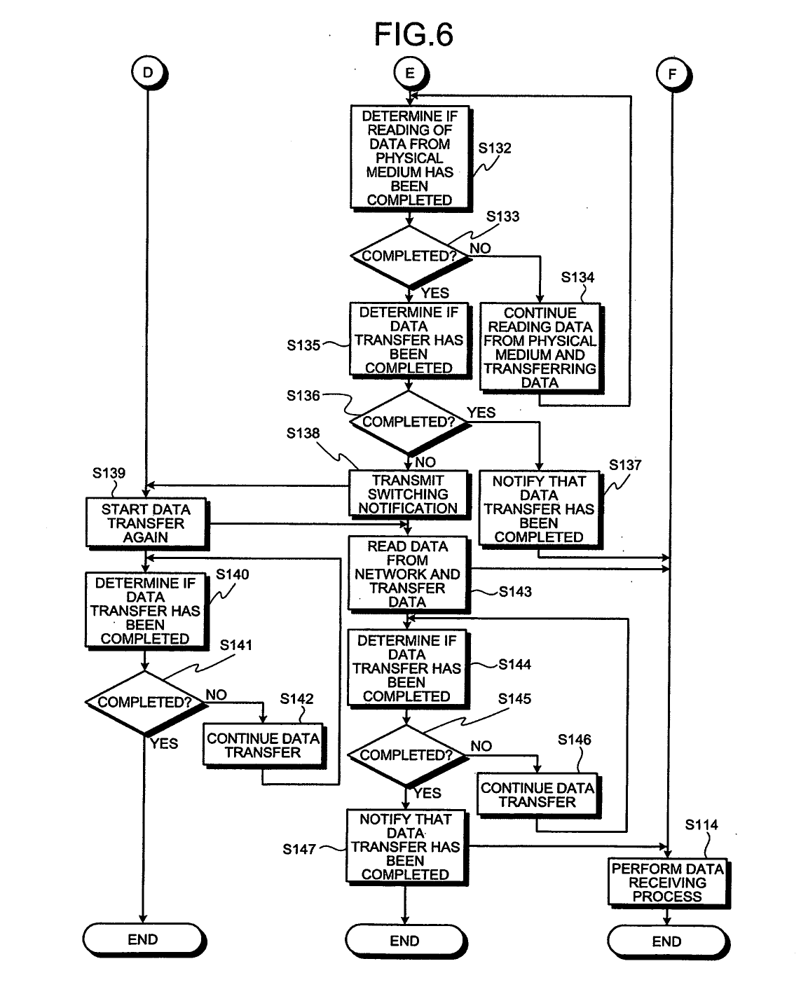

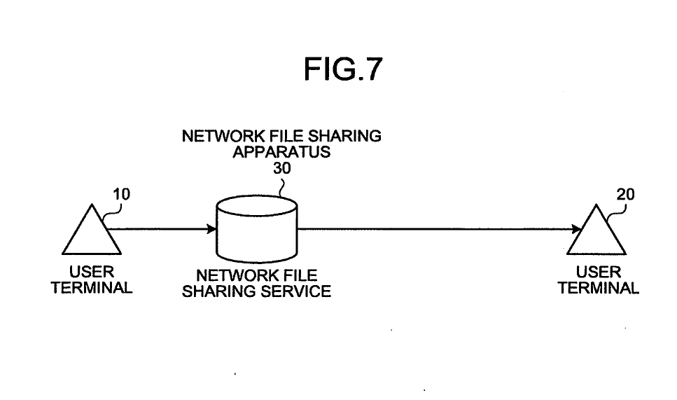

A process of the data transfer according to the embodiment are described below with reference to FIGS. 4 to 6. FIGS. 4 to 6 are flowcharts of the data transfer process according to the embodiment. As shown in FIG. 4, the user terminal 10 transmits data to the transmitter-side access point 100 (step S101), and determines if the data transmission has been completed (step S102). If not (NO at step S103), the system control returns to step S101. If the data transmission has been completed (YES at step S103), the data transfer process ends at the user terminal 10.

The transmitter-side access point 100 starts receiving the data from the user terminal 10 (step S104). At step S104, the file copying unit 130 records the amount of the received data on the received data counter 150 and the physical-medium stored data counter 160, while storing the data in the file DB 140 and the physical medium 170.

The file copying unit 130 creates file information, and stores the file information in the file information DB 250 (step S105). Then, the delay measuring unit 120 transmits a probe packet to the receiver-side access point 200 (step S106), and the delay measurement responding unit 220 responds to the probe packet (step S107). The delay measuring unit 120 measures the transmission delay (step S108), and the file copying unit 130 calculates the switching threshold based on the transmission delay (step S109).

At the receiving side, the user terminal 20 issues a data receiving request to the receiver-side access point 200 (step S110), and the source determining unit 230 determines if the requested file is present by referring to the file information DB 250 (step S111). If the requested file is not present (NO at step S112), an error notification is sent to the user terminal 20 (step S113), and the user terminal 20 performs a data receiving process (step S114). At step S114, upon receiving the error notification, the user terminal 20 outputs information on the display indicating that the requested data is not present. On the other hand, for example, upon receiving the requested data, the user terminal 20 stores the received data in a storage device thereof. Having been notified that the data transfer has been completed by the receiver-side access point 200, the user terminal 20 outputs the information on the display or the like.

If the requested file is present (YES at step S112), the source determining unit 230 requests the transmitter-side access point 100 to transfer the data (step S115). In response to the data transfer request, the file copying unit 130 starts transferring the data (step S116). The source determining unit 230 receives the data from the transmitter-side access point 100 over the network, and starts transferring the data to the user terminal 20 (step S117).

In the transmitter-side access point 100, the file copying unit 130 determines if the amount of the data recorded on the received data counter 150 has exceeded the switching threshold (step S118). If the amount of the data has not exceeded the switching threshold (NO at step S119), the data is kept being received and transferred (step S120), and the system control returns to the step S118.

If the amount of the data has exceeded the switching threshold (YES at step S119), the file copying unit 130 determines to transport the data using the physical medium 170, disconnects the physical medium 170 from the transmitter-side access point 100 (step S121), and stops updating the physical-medium stored data counter 160 (step S122). The physical medium 170 disconnected from the transmitter-side access point 100 at step S121 is transported to the receiver-side access point 200 via, for example, an airplane.

At the receiver-side access point 200, the source determining unit 230 determines if the data transfer request has been completed (step S123). If the data transfer request has been completed (YES at step S124), the source determining unit 230 notifies the user terminal 20 that the data transfer request has been completed (step S125).

If the data transfer request has not been completed (NO at step S124), the source determining unit 230 determines if the physical medium 170 is present in the receiver-side access point 200 (step S126). If the physical medium 170 is not present (NO at step S127), the data is kept being received and transferred over the network (step S128), and the system control returns to step S123.

If the physical medium 170 is present at the receiver-side access point 200 (YES at step S127), the switching notification transmitting unit 260 transmits the switching notification to the transmitter-side access point 100 (step S129). In response to the received switching notification, the file copying unit 130 stops transmitting the data (step S130).

The source determining unit 230 at the receiver-side access point 200 reads the data from the physical medium 170, and transfers the data to the user terminal 20 (step S131). Subsequently, the source determining unit 230 determines if reading of the data from the physical medium 170 has been completed (step S132). If not (NO at step S133), the source determining unit 230 keeps reading the data from the physical medium 170 and transferring the data to the user terminal 20 (step S134), and the system control returns to step S132.

If reading of the data from the physical medium 170 has been completed (YES at step S133), the source determining unit 230 determines if the data transfer request has been completed (step S135). If the data transfer request has been completed (YES at step S136), the source determining unit 230 notifies the user terminal 20 of the completion of the data transfer request (step S137).

If the data transfer request has not been completed (NO at step S136), the switching notification transmitting unit 260 transmits the switching notification to the transmitter-side access point 100 (step S138). Upon receiving the switching notification, the file copying unit 130 starts the data transfer request over the network again (step S139). The transmitter-side access point 100 then determines if the data transfer request has been completed (step S140). If the data transfer request has not been completed (step S141), the transmitter-side access point 100 keeps transferring the data (step S142), and the system control returns to the step S140. If the data transfer request has been completed (YES at step S141), the data transfer request process ends at the transmitter-side access point 100.

The receiver-side access point 200 reads the data from the network, and transfers the data to the user terminal 20 (step S143). The receiver-side access point 200 then determines if the data transfer request has been completed (step S144). If the data transfer request has not been completed (NO at step S145), the receiver-side access point 200 keeps transferring the data (step S146), and the system control returns to the step S144.

If the data transfer request has been completed (YES at step S145), the receiver-side access point 200 notifies the user terminal 20 of the completion of the data transfer request (step S147), and the data transfer request process ends.

Because the transmitter-side access point 100 and the receiver-side access point 200 transmit the data using the network or the physical medium 170 in the manner described above, the throughput can be increased with low cost.

As described above, according to the embodiment, the transmitter-side access point 100 measures the transmission delay between the transmitter-side access point 100 and the receiver-side access point 200, and the switching threshold is calculated based on the measured transmission delay. While the amount of the data transmitted from the user terminal 10 does not exceed the switching threshold, the transmitter-side access point 100 transmits the data over the network in response to the request from the receiver-side access point 200. When the amount of data exceeds the switching threshold, the physical medium 170 is transported to the receiver-side access point 200, and the receiver-side access point 200 obtains the data from the transported physical medium 170 and transfers the obtained data to the user terminal 20. Therefore, the throughput can be increased with low cost without updating the existing user interfaces of the user terminals 10 and 20.

As set forth hereinabove, according to an embodiment of the present invention, upon data transfer from a source terminal to a destination terminal, the data transfer time from the source terminal to the destination terminal is measured, and it is determined whether to transfer the data over the network or to transport the data as being stored in a physical medium from the source terminal to the destination terminal. Because the destination terminal obtains the data from the network connected to the source terminal or from the transported physical medium, the throughput of data transfer request can be increased with low cost.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A data transfer system that transfers data from a source terminal to a destination terminal; the data transfer system comprising:
a measuring unit that measures transfer time taken to transfer data from the source terminal to the destination terminal;
a determining unit that determines, based on the transfer time measured by the measuring unit, whether to transfer the data over a network from the source terminal to the destination terminal or to transport the data as being stored in a physical medium from the source terminal to the destination terminal; and
an obtaining unit that obtains the data from any one of the network connected to the source terminal and the physical medium, wherein
when an amount of data transferred over the network to the destination terminal exceeds a predetermined threshold, the data is transported as being stored in the physical medium.

2. The data transfer system according to claim 1, wherein, when the physical medium is transported from the source terminal while obtaining data from the source terminal over the network, the obtaining unit stops obtaining the data over the network and obtains the data from the physical medium.

3. The data transfer system according to claim 2, wherein, when a portion of data is not stored in the physical medium transported from the source terminal, the obtaining unit obtains the portion from the source terminal over the network.

4. A data transfer method for transferring data from a source terminal to a destination terminal, the data transfer method comprising:
measuring transfer time taken to transfer data from the source terminal to the destination terminal;
determining whether to transfer the data over a network from the source terminal to the destination terminal or to transport the data as being stored in a physical medium from the source terminal to the destination terminal based on the transfer time and whether an amount of data transferred over the network to the destination terminal exceeds a predetermined threshold; and
obtaining the data from any one of the network connected to the source terminal and the physical medium.

5. The data transfer method according to claim 4, wherein the obtaining includes stopping obtaining the data over the network and obtaining the data from the physical medium when the physical medium is transported from the source terminal while data is being obtained from the source terminal over the network.

6. The data transfer method according to claim 5, wherein the obtaining includes obtaining, when a portion of data is not stored in the physical medium transported from the source terminal, the portion from the source terminal over the network.

7. A data transfer apparatus that transfers data to a destination terminal, the data transfer apparatus comprising:
a measuring unit that measures transfer time taken to transfer data to the destination terminal; and
a determining unit that determines, based on the transfer time measured by the measuring unit, whether to transfer the data over a network to the destination terminal or to transport the data as being stored in a physical medium to the destination terminal.
